(19) United States
(12) Patent Application Publication
(10) Pub. No.: US 2022/0278460 A1
(43) Pub. Date: Sep. 1, 2022

(54) ANTENNA WITH TWO OR MORE FEEDING POINTS

(71) Applicant: WISENSE TECHNOLOGIES LTD., Tel Aviv (IL)

(72) Inventors: Zeev ILUZ, Tel Aviv (IL); Moshe Moshik COHEN, Tel Aviv (IL)

(73) Assignee: WISENSE TECHNOLOGIES LTD., Tel Aviv (IL)

(21) Appl. No.: 17/187,824

(22) Filed: Feb. 28, 2021

(51) Int. Cl. H01Q 21/00; H01Q 21/24; H01Q 21/06

(52) U.S. Cl. CPC H01Q 21/0075; H01Q 21/24; H01Q 21/065

(57) ABSTRACT

An antenna with multiple feeds of single polarization comprises an array of multiple antenna elements. An antenna assembly comprises a radiation unit, multiple RF feeding locations and a waveguiding structure configured to control the amplitude and phase of feeding signals that are directed to the feeding locations for achieving defined radiation beam shape and radiation bandwidth. The waveguiding structure is adapted to provide the RF signals to the multiple feeding locations in one of a single polarization and a linear polarization.

### BACKGROUND OF THE INVENTION

Antennas and antenna arrays are known in the art. For example, a patch antenna array includes a set of flat metal surfaces (antennas) that, when excited, emit radio waves. More generally, patch antennas are used to convert propagating electromagnetic waves into alternating current or vice versa. Typically, feeding, the causing of antennas in a patch antenna array to radiate by supplying to the antennas the appropriate electric signals, is done, for example, using a microstrip, an electrical transmission line used to convey microwave-frequency signals or using a stripline, a transverse electromagnetic (TEM) transmission line, or using a substrate integrated waveguide (SIW).

Systems and methods for converting electromagnetic waves into alternating current are also known. Series feeding is a technique that includes feeding an array of antennas from one of its ends or edges. However, this technique suffers from drawbacks. For example, the array's main lobe peak may be shifted from boresight as a function of the signal's frequency, where this tilt is caused by the accumulative phase error between the radiating elements. Additionally, when series feeding is used, antenna matching bandwidth is decreased as the number of radiating elements (antennas) is increased.

Some known methods reduce the lobe shift by feeding an antenna array from the center of the array (instead of feeding it from one of its edges), thus reducing the phase error. However, a disadvantage of known systems, methods and techniques that use center feeding is the usage of space of a surface that includes the antennas, for routing (placement of) the feeding lines to the centers of the arrays on a surface.

### SUMMARY OF THE INVENTION

An antenna with multiple feeds of single polarization is presented.

In some embodiments, the antenna comprises an array of multiple radiating antenna elements.

In some embodiments, the polarization of the antenna is linear.

In some embodiments, the polarization of the array of multiple radiating antenna elements is linear.

In some embodiments, the antenna comprises an array of multiple radiating antenna elements.

In some embodiments, the antenna further comprises a plurality of RF feeding points, wherein locations of the feeding points are symmetrical with respect to a phase center of the antenna.

In some embodiments, the antenna further comprises a plurality of RF feeding points, wherein the relation between the number of radiating elements and the number of the feeding point is larger than 2.

An antenna assembly is presented comprising a radiation unit, multiple RF feeding locations and a waveguiding structure configured to control the amplitude and phase of feeding signals directed to the feeding locations for achieving defined radiation beam shape and radiation bandwidth. The waveguiding structure is adapted to provide the RF signals to the multiple feeding locations in one of a single polarization and a linear polarization.

In some embodiments of the antenna assembly, the waveguiding structure and the radiation unit are disposed in separate planes.

In some embodiments of the antenna assembly, the radiation unit comprises an array of plurality of antenna elements.

In some embodiments, the antenna assembly comprises a single transmit/receive port configured to feed the at least two radiating apertures via said waveguiding structure.

In some embodiments, the antenna assembly comprises a radiation beam axis for transmission at a central wavelength λ, wherein the tilt of angle of the radiation beam axis is substantially zero degrees for the entire operational bandwidth.

In some embodiments, the antenna assembly has overall energetic efficiency of no less than 75%.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a schematic block diagram of an antenna according a first embodiment of the present invention;

FIG. 1B is a schematic block diagram of an antenna according a second embodiment of the present invention;

FIG. 1C is a schematic block diagram of an antenna according a third embodiment of the present invention;

FIG. 1D is a schematic block diagram of an antenna according a fourth embodiment of the present invention;

FIG. 2A is a schematic cross section, side view, of components of an apparatus, assembly or system, according to some embodiments of the present invention;

FIG. 2B is a schematic partial isometric illustration of a section of the assembly of FIG. 2A, according to some embodiments of the invention;

FIG. 3 schematically depicts partial view of the assembly of FIG. 2A, according to some embodiments of the invention;

FIG. 4A schematically depicts an optional arrangement of vias in assembly of FIG. 2A, FIG. 3 and FIG. 4, according to some embodiments of the invention;

FIG. 4B schematically depicts top view of an arrangement vias and RF coupling elements, according to some embodiments of the invention

FIG. 5 is a schematic partial isometric view of an antenna assembly, according to some embodiments of the invention; and

FIG. 6 schematically depicts a vias arrangement according to some embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

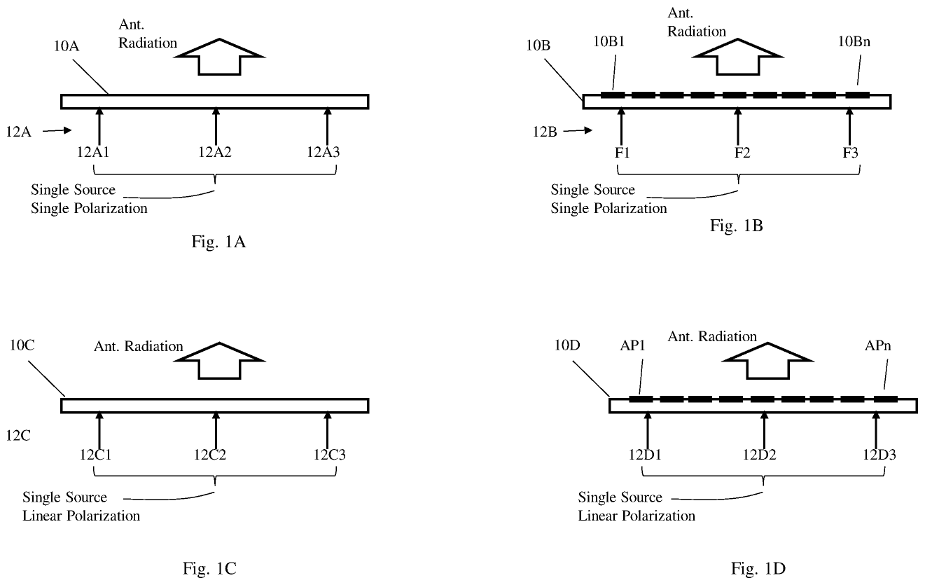

Reference is made now to FIGS. 1A, 1B, 1C and 1D, which are schematic simplified block diagrams of four basic embodiments of antenna, according to some embodiments of the present invention. FIG. 1A is a schematic block diagram of antenna 10A configured to be fed by electromagnetic (EM) RF signal at multiple feed locations 12As (marked 12A1, 12A2 and 12A3 in the drawing, yet more feeding locations may be used). The EM RF signal is fed with a single polarization. FIG. 1B is a schematic block diagram of antenna 10B configured to be fed by electromagnetic (EM) RF signal at multiple feed locations 12Bs (marked 12B1, 12B2 and 12B3 in the drawing, yet more feeding locations may be used). The EM RF signal is fed with a single polarization. Antenna 10B comprises an array of multiple antenna elements 10B1-10Bn. Antenna elements 10B1-10Bn may be antenna patches, 3D slot elements, printed slot elements, horn-type elements, tapered slot antenna elements (e.g., Vivaldi type), sinuous type elements, spiral elements, etc. FIG. 1C is a schematic block diagram of antenna 10C configured to be fed by electromagnetic (EM) RF signal at multiple feed locations 12Cs (marked 12C1, 12C2 and 12C3 in the drawing, yet more feeding locations may be used). The EM RF signal is fed with a linear polarization. FIG. 1D is a schematic block diagram of antenna 10D configured to be fed by electromagnetic (EM) RF signal at multiple feed locations 12Ds (marked 12D1, 12D2 and 12D3 in the drawing, yet more feeding locations may be used). The EM RF signal is fed with a linear polarization. Antenna 10D comprises an array of multiple antenna elements 10D1-10Dn.

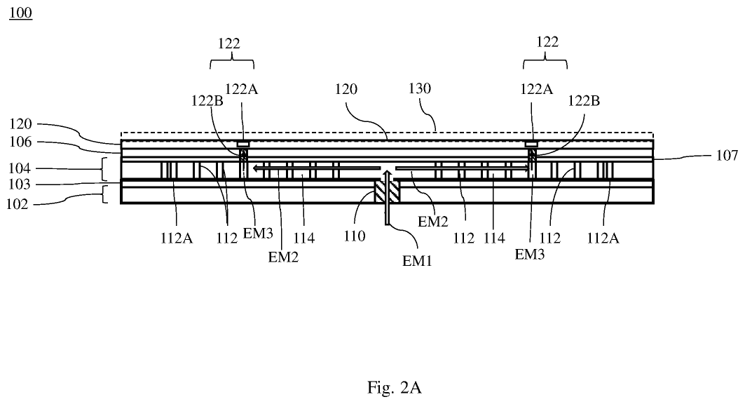

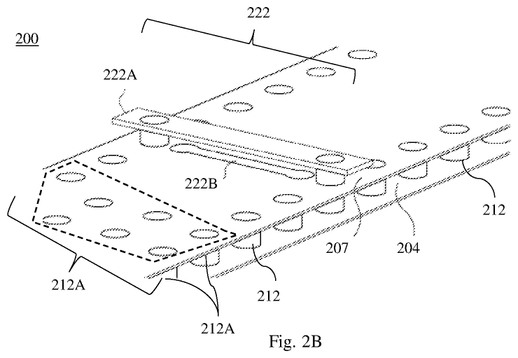

Reference is made to FIG. 2A, which is a schematic cross section, side view, of components of an apparatus, assembly or system 100, according to some embodiments of the present invention. As shown, apparatus 100 may include a first non-conductive layer (part or portion) 106 made of a dielectric material and an antenna unit 120 disposed on layer 106. As shown, assembly 100 may include a second non-conductive layer (part or portion) 104 adapted to convey electromagnetic waves.

Element 107, which may be a layer disposed on the side of layer 106 opposite to antenna unit 108, may be a conductive (e.g., copper) wall, plane or surface providing electrical ground. Element, surface or wall 103 may be a conductive (e.g., copper) plane or surface providing electrical ground.

Elements 112 may be a plurality of vias made of conductive material (e.g., copper) that connect surfaces or walls 103 and 107. Regions or spaces 114 are formed between the plurality of conductive spacers (such as vias) 112 that are disposed between conductive layers 103 and 107 and may be of any suitable medium, e.g., air or any other substance surrounding system 100. Regions or spaces between and/or around elements of apparatus, assembly or system 100 may be filled with any printed circuit board (PCB) material or substrate, e.g., fiberglass. For example, the space between antenna unit 120 and plane or wall 107, e.g., layer 106, may be filled with fiberglass. Conductive layer 103 may be disposed, on its side opposite to conductive layer 107, on a third non-conductive layer 102, that may be made of, for example, fiberglass, and may also serve, in some embodiments, as a mechanical support for system 100.

A feeding port 110 may be made through layer 102, adapted to act as a feeding port for a RF energy. In some embodiments, feeding port 110 may be adapted to form a waveguide cavity for allowing a path for RF signals from a RF generator (not shown) through the waveguide cavity to feed assembly 100 the RF energy. Feeding port 110 is formed in the layer 102 that is positioned on the opposite side (the assembly bottom) to antenna unit 120 in assembly 100, and RF wave propagating in it enters assembly 100 perpendicular to the plane of antenna unit 120. This design enables feeding RF energy to antenna assembly 100 without occupying space inside assembly 100 as is common with planar assemblies fed from one of their sides, where the waveguide cavity passes along substantially half of the assembly length. Further details of the propagation path of EM energy fed to assembly 100 are presented below.

Antenna unit 120 may be fed with RF signals (or may provide Electromagnetic (EM) signals received by antenna unit 120) from two or more RF feeding assemblies disposed along antenna unit 120. In the example of FIG. 1, two RF feeding assemblies 122 are shown, yet it would be apparent that three or more feeding assemblies may be used, to fit specific antenna system designs. Each RF feeding assembly 122 may comprise RF coupling element 122A and RF path cavity 122B made through layer 106.

Each of first non-conductive layer 106, second non-conductive layer 104 and third non-conductive layer 102 may be made of any dielectric material, for example a dielectric material having dielectric constant of 3 and zero electrical conductivity.

Arrows marked EM1m EM and EM3 in FIG. 1 depict the path of the EM energy from the feeding port 110 (EM1), splitting to two directions through layer 104 (EM2) and through RF feeding assemblies 122 to antenna unit 120 (EM3). In some embodiments, all of the feeding RF signals EM3 are of a single polarization. In some embodiments, all of the feeding RF signals EM3 are of a linear polarization. In some embodiments, the locations of feeding points EM3 are symmetrical with respect to the antenna phase center (APC). In some embodiments, the relation between the number of radiating elements and the number of feeding points is larger than two. Group of vias marked 112A, positioned at the left most and right most ends of the vias, are configured to reflect back the EM signal approaching from the central feeding port 110 in a manner that combines with the incoming EM energy signal against the location of RF feeding assembly 122 in a predesigned amplitude and phase. It would apparent that the transform of EM1, which propagates as spatial wave, into a planar EM signal at EM2 is achieved by the special arrangement vias 112 and vias 112A.

In some embodiments, assembly 100 may further comprise external protective layer 130 disposed on antenna unit 120, adapted to protect antenna unit from mechanical harms/protective layer 130 may be made of any nonconductive layer that has high transparency figure for RF transmission.

Reference is made now to FIG. 2B, which is a schematic partial isometric illustration of section 200 of assembly such as assembly 100 of FIG. 1, according to some embodiments of the invention. Section 200 depicts the area in assembly 100 where RF feeding assembly 222 (similar to RF feeding assembly 122 of FIG. 1) is installed at the left side of assembly 100 of FIG. 1. It would be apparent that, in the example of assembly 100 of FIG. 1, RF feeding assembly 222 of the right side may look as a mirror view of FIG. 2 about mirror line crossing transversely assembly 100 trough feeding port 110. The combined RF signal formed against RF feeding assembly 222, passing through aperture (or cavity) 222B and feeds antenna, such as antenna unit 120 by means of RF coupling element 222A.

Aperture or cavity 222B in layer 207 may enable an electromagnetic wave guided by layer 204 to reach a coupling element 222 that may be included in, be part of, or be operatively connected to, antenna unit 120.

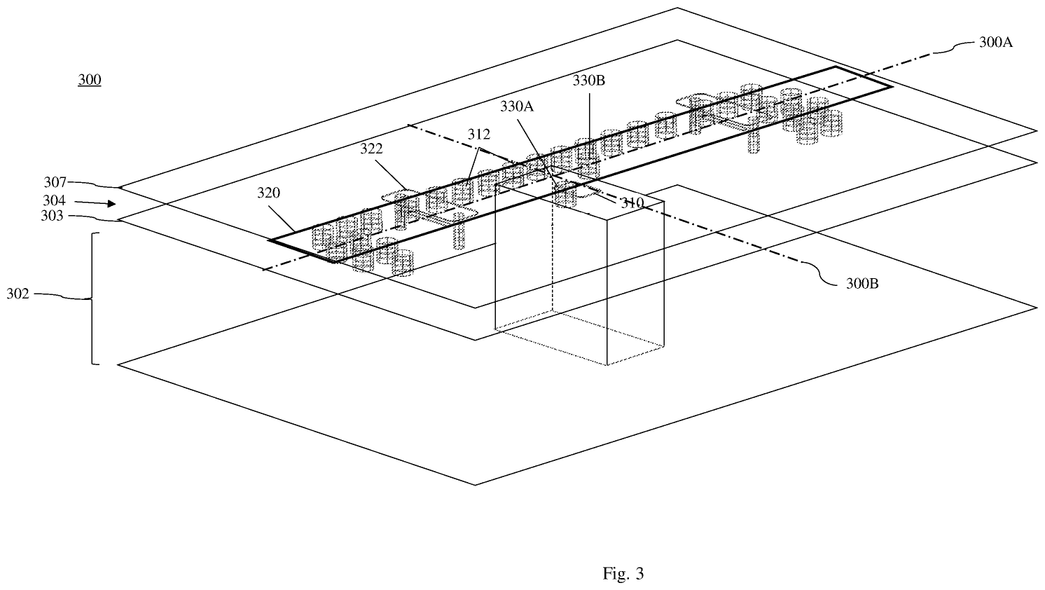

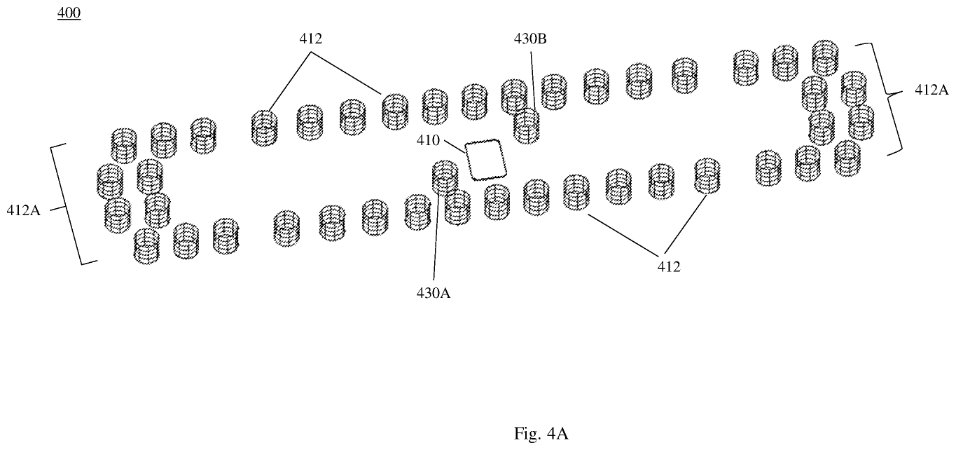

Reference is made now to FIG. 3, which schematically depicts partial view of assembly 300, which is similar to assembly 100 of FIG. 1 and to assembly 200 of FIG. 2, according to some embodiments of the invention. For the sake of clarity of the drawing, some vias 312 of a row of vias closer to the viewer were deleted, yet it would be apparent that, according to some embodiments of the invention, the missing vias in FIG. 3 may form a row of vias identical to the mirroring row extending opposite on the side farther from the viewer and marked 312. Antenna unit 320, which may be similar to antenna unit 120 of FIG. 1 and to antenna 220 of FIG. 2, extends parallel to layer 307m which may be similar to layer 107 of FIG. 1 and to layer 207 of FIG. 2 and parallel to layer 303 which may be similar to layer 103 of FIG. 1 and to layer 203 of FIG. 2. Assembly 300 further comprises RF signal splitting and phase shaping vias 330A and 330B, each positioned aside RF signal entrance cavity 310, where via 31A is positioned off central longitudinal line 300A to one side and off transverse central line 300B to one side, and via 330B is positioned off central longitudinal line 300A to the other side and off transverse central line 300B to the side.

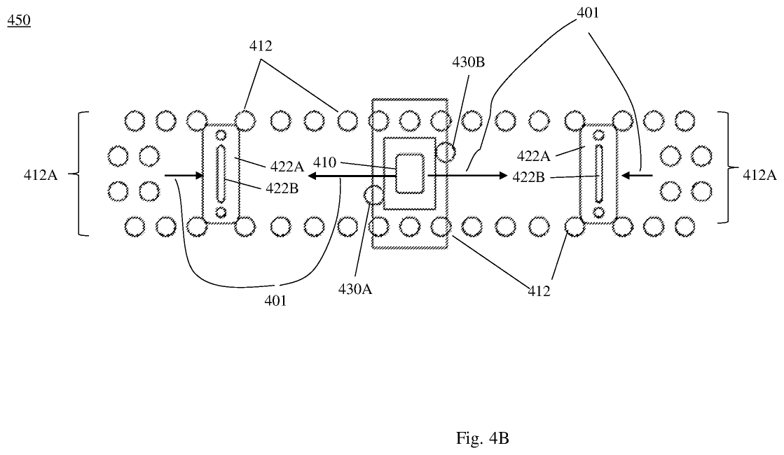

Reference is made now to FIG. 4A, which schematically depicts an optional arrangement 400 of vias 412 and vias 412A, similarly to vias 112 and 112A of FIG. 1, to vias 212 and 212A of FIG. 2 and to vias 312 and 312A of FIG. 3, according to some embodiments of the invention. Vias arrangement 400 further depict the location of vias 430A and 430B, configured and located so as to split EM signal coming through entrance cavity to two opposite directions and to shape the phases of the split signals in coordination with each other, similarly to vias 330A and 330B of FIG. 3.

Reference is made now also of FIG. 4B, which schematically depicts top view of arrangement 450 of vias and RF coupling elements, according to some embodiments of the invention. For the sake of clarity, this view is presented with other layers, such as layer 107 and 106 are removed, or made transparent, in order to clearly show the relative locations of the various elements in FIG. 4B. Vias 412 and 412A are similar to vias 112, 112A and 212, 212A. The specific arrangement of vias 412 forms, with conductive layers 103 and 107 of FIG. 1 (not shown in the current drawing), a planar wave guide that directs the EM signal entering from entrance cavity 419 as demonstrated by arrows 401 sideways from the center, and some of the EM signals are also reflected back from end arrangement of vias 412A operating as EM signal reflector, which not only reflects the EM signal but also shapes its phase so as to combine with the EM signal coming directly from cavity 410 in a desired form. The combined EM signals are directed via RF path cavity 422B to RF coupling element 422A to excite antenna unit connected thereto (not shown in FIG. 4B).

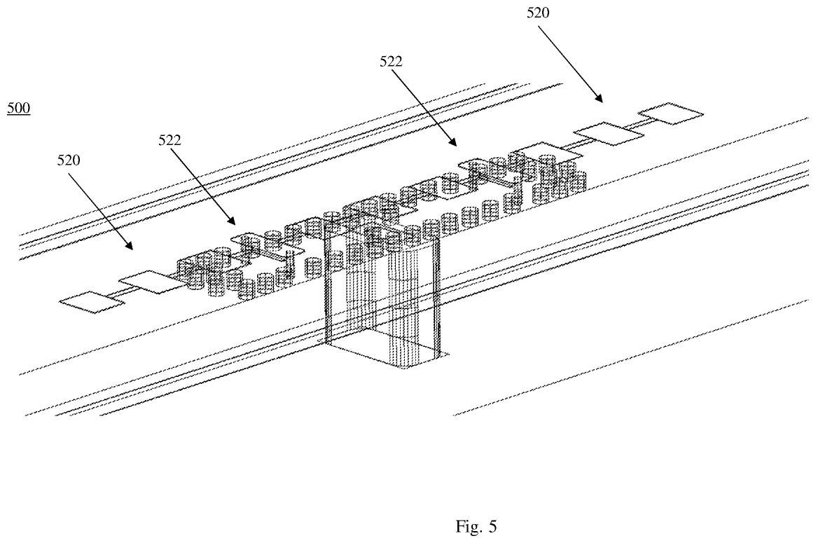

Reference is made now to FIG. 5, which is a schematic partial isometric view of antenna assembly 500, according to some embodiments of the invention. Assembly 500 may be similar to assembly 100 of FIG. 1 with the variation of antenna unit, which is presented in FIG. 5 in the form of patch antenna 520 that is excited by RF coupling assembly 522, similar to RF coupling assembly 122 of FIG. 1 and to RF coupling assembly 22 of FIG. 2. It would be apparent to those skilled in the that other forms or types of antennas may be used as antenna unit, such as antenna unit 120 of FIG. 1, and the chosen antenna may be fed with EM signals from two or more locations along the antenna, for example RF coupling assemblies 522 may be positioned in the middle of a given patch of patch antenna 520. It would be apparent that other antenna elements may be used according to some embodiments of the invention.

The location of RF coupling assemblies 522 may be set to meet specific design requirements, such as minimal beam tilt as function of the wavelength, bandwidth, and the like. Further, the specific location of RF coupling assemblies 522 may be positioned centered between two adjacent patches of patch antenna 520, as shown in FIG. 5, yet other relative locations of RF coupling assemblies 522 may be selected, in accordance with the desired performance of assembly 500.

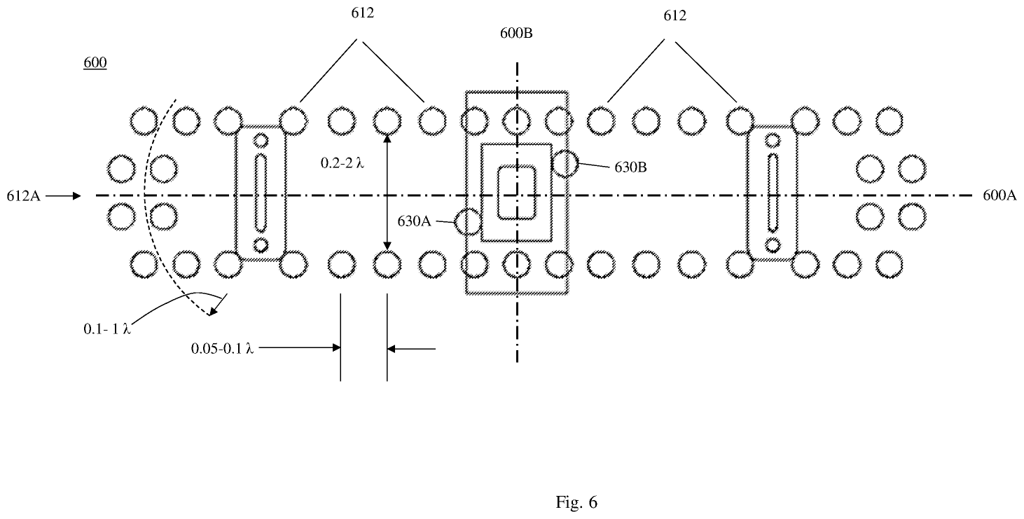

Reference is made now to FIG. 6, which schematically depicts vias arrangement 600 according to some embodiments of the present invention. Vias arrangement 600 may be part of assembly 100 of FIG. 1, of assembly 200 of FIG. 2, or of assembly 500 of FIG. 5. Arrangement 600 of vias depicts optional physical dimensions of the vias arrangement, in terms of a nominal wavelength λ, e.g., the central wavelength of the antenna. According to some embodiments of the invention, the longitudinal distance (measured parallel to longitudinal central line 600A) between two adjacent vias 612 may be in the range of 0.05-0.1λ. The transverse distance between two rows of vias (measured parallel to transverse central line 600B) may be in the range of 0.2-2λ. End of reflecting vias 612A may be arranged, for example, in two arcs having a radius in the range 0.1-1λ. The dimensions presented above serve as an example of the design of the vias. It would be apparent that other design parameters may be used, such as vias diameter and the distance along the longitudinal and the transverse lines of vias 630A and 630B.

The antenna assemblies described above excel in maintaining a steady angle of the radiation beam axis for a wide bandwidth about the central operating wavelength. For example, the tilt of the angle of the radiation beam of transmission at a central wavelength of antenna assemblies described above, having a radiation beam axis for transmission at a central wavelength λ, may be substantially zero degrees for the entire bandwidth.

The antenna assemblies described above excel also in demonstrating high overall efficiency. Overall energetic efficiency of antenna assemblies described above may be expressed as the ratio ε_{POWER}, which may be defined as

$${ε}_{POWER} = \frac{{P}_{OUT}}{{P}_{IN}} ,$$

where the output power P_{OUT} is the power. For example, antenna according to some embodiments of the invention may demonstrate ε_{POWER} that equals or is higher than 75%.

In the description and claims of the present application, each of the verbs, “comprise” “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Some embodiments utilize only some of the features or possible combinations of the features. Variations of embodiments of the invention that are described, and embodiments comprising different combinations of features noted in the described embodiments, will occur to a person having ordinary skill in the art. The scope of the invention is limited only by the claims.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An antenna with multiple feeds of single polarization.

2. The antenna of claim 1, further comprising an array of multiple radiating antenna elements.

3. The antenna of claim 1, wherein the polarization is linear.

4. The antenna of claim 2, wherein the polarization is linear.

5. The antenna of claim 3, further comprising an array of multiple radiating antenna elements.

6. The antenna of claim 1, further comprising a plurality of RF feeding points, wherein locations of the feeding points are symmetrical with respect to a phase center of the antenna.

7. The of antenna of claim 2, further comprising a plurality of RF feeding points, wherein a relation between a number of radiating elements and a number of the RF feeding points is larger than 2.

8. An antenna assembly comprising:
a radiation unit,
multiple RF feeding locations, and
a waveguiding structure configured to control the amplitude and phase of feeding signals directed to said feeding locations for achieving defined radiation beam shape and radiation bandwidth,
wherein the waveguiding structure is adapted to provide the RF signals to the multiple feeding locations in one of a single polarization and a linear polarization.

9. The antenna assembly of claim 8, wherein the waveguiding structure and the radiation unit are disposed in separate planes.

10. The antenna assembly of claim 8, wherein the radiation unit comprises an array of plurality of antenna elements.

11. The antenna assembly of claim 8, further comprising a single transmit/receive port configured to feed the at least two radiating apertures via said waveguiding structure.

12. The antenna assembly of claim 8, further comprising a radiation beam axis for transmission at a central wavelength λ, wherein the tilt of angle of the radiation beam axis is substantially zero degrees for the entire operational bandwidth.

13. The antenna assembly of claim 8, further comprising an overall energetic efficiency of no less than 75%.
